(19) United States
(12) Patent Application Publication
(10) Pub. No.: US 2010/0297393 A1
(43) Pub. Date: Nov. 25, 2010

(54) METHOD FOR SURFACE FROSTING OF GLASS PRODUCT

(76) Inventor: Chien-Ping WU, Hsinchu City (TW)

Correspondence Address: LEONG C. LEI, PMB # 1008, 1839 YGNACIO VALLEY ROAD, WALNUT CREEK, CA, 94598, US

(21) Appl. No.: 12/760,538

(22) Filed: Apr. 14, 2010

(30) Foreign Application Priority Data
May 20, 2009 (TW) 098116621

(51) Int. Cl. C03C 15/00; B32B 17/00; B32B 3/00

(52) U.S. Cl. 428/141; 216/98

(57) ABSTRACT

Provided is a method for surface frosting of glass product, wherein a glass product is first immersed in a pre-treatment solution having a composition including water (H₂O) 60-80 wt %, hydrofluoric acid (HF) 10-20 wt %, and nitric acid (HNO₃) 10-20 wt % for approximately 5 seconds to remove grease/oil and/or contamination from a surface of the glass product, then immersed in a frosting solution having a composition including nitric acid (HNO₃) 15-40 wt %, ammonium hydrofluoride (NH₄HF₂) 30-60 wt %, hydrofluoric acid (HF) 0-10 wt %, water (H₂O) 0-45 wt %, and hydrochloric acid (HCl) 0-1 wt % for approximately 1-5 minutes, and finally rinsed with water. As such, the surface of the glass product so treated forms a surface texture that provides smooth tactility of hand touch and shows an outer appearance of a scale like pattern formed on the surface of the glass product.

### TECHNICAL FIELD OF THE INVENTION

The present invention generally relates to a method for surface frosting process of glass product, which is a frosting process that forms scale like patterns on a surface of glass product by applying a hydrofluoride solution to corrode the surface of glass product.

### DESCRIPTION OF THE PRIOR ART

Conventionally, surface frosting of a glass product is performed by immersing the glass product in a frosting solution containing fluoric acid (HF) and ammonium hydrofluoride (NH₄HF₂) for 10-20 seconds, allowing the surface of the glass product to be corroded in a very short period of time to form frosted texture. This operation is based on that the addition of ammonium hydrofluoride (NH₄HF₂) in fluoric acid (HF) causes alkaline metal ions contained in the glass composition to dissolve and precipitate. The dissolution of these constituents leads to damage of glass skeleton having minute scars, allowing the formation of uniform tiny recesses in the glass surface thereby showing the texture of frosted glass.

However, due to the miniature recesses in the glass surface, hand marks are easily left on the glass surface. Further, if it is desired to perform gold foil stamping on the frosted glass surface by means of screen printing, due to the frosted texture of the glass surface that is the substrate on which printing is to be carried out, the substrate must be subjected to pre-treatment to make the surface smooth and glossy before the printing can be performed. This takes additional labor and time. In addition, the substrate treatment is carried out in such a way that the tiny recesses formed in the portion of the glass surface on which the gold foil stamping is to be carried out are filled and leveled up. Thus, the printing for substrate treatment and the foil stamping may get deviated from each other and contour burring of the foil-stamped part may occur, which damages the value of the product.

### SUMMARY OF THE INVENTION

The present invention provides a method for surface frosting of glass product, wherein a pre-treatment solution having a composition including water (H₂O) 60-80 wt %, hydrofluoric acid (HF) 10-20 wt %, and nitric acid (HNO₃) 10-20 wt % is first prepared to receive a glass product immersed therein for 3-10 seconds, preferably about 5 seconds, to remove grease/oil and/or contamination from a surface of the glass product. The glass product that has been immersed in the pres-treatment solution is immersed in a frosting solution having a composition including nitric acid (HNO₃) 15-40 wt %, ammonium hydrofluoride (NH₄HF₂) 30-60 wt %, hydrofluoric acid (HF) 0-10 wt %, water (H₂O) 0-45 wt %, and hydrochloric acid (HCl) 0-1 wt % for approximately 1-5 minutes and then rinsed with water to thereby form a glass surface that has a surface texture providing smooth tactility of hand touch and showing an outer appearance of a scale like pattern formed on the surface of the glass product.

A glass product that is processed with the frosting method according to the present invention shows a surface tactility substantially identical to the conventional frosted glass that is treated with the conventional way of frosting. Yet, the surface of the glass product processed according to the present invention shows, as a whole, a scale like pattern that provides a result of surface treatment that is completely different from the conventional techniques. Even it is desired to carry out foil stamping directly on the glass surface so treated, the printed portion still shows glossy. The scale like pattern also helps providing a glittering surface treatment result for the glass product.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart of a method for surface frosting of glass product according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

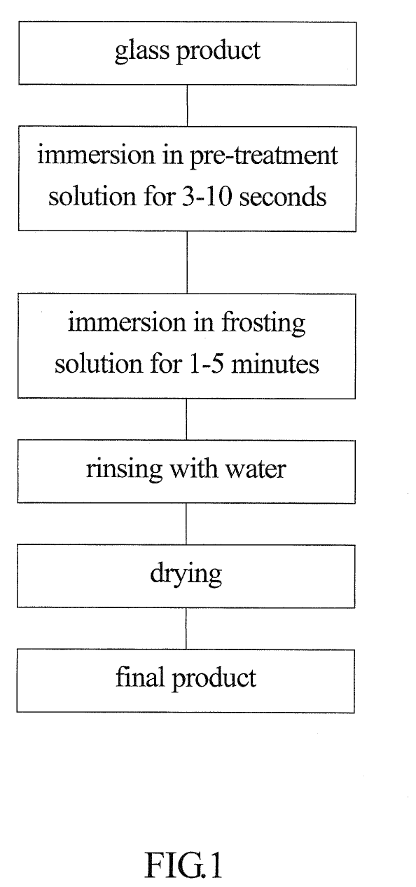

The present invention provides a method for surface frosting of glass product, which will be described by taking a color glass bottle as a non-limitative example for explanation with reference to FIG. 1, where the glass bottle is made of soda-lime glass (Na₂O—CaO—SiO₂). A frosting process according to the present invention comprises, in sequence, the following four steps: pre-treatment, frosting, rinsing, and drying. It is noted that in the following description, the constituent components of solutions that are used in the pre-treatment step and the frosting step are all expressed in term of percentage by weight.

(1) Pre-treatment: This step, which is adopted to remove any glass component precipitating on the surface of the glass bottle and other grease/oil attached to the glass bottle surface, is carried out by immersing the glass bottle in a pre-treatment solution that belongs to fluoric acid family. The composition of pre-treatment solution includes water (H₂O) 60-80%, hydrofluoric acid (HF) 10-20%, and nitric acid (HNO₃) 10-20%. The immersion time in the pre-treatment solution is 3-10 seconds, preferably approximately 5 seconds. However, for glass bottles that have a surface carrying baked varnish or resin coating or the surface being contaminated by oily or greasy contamination to various extents, the immersion in the pre-treatment must sustain until the contamination is surely removed. The pre-treatment step only removes the surface contamination from the glass bottle and other surface conditions of the bottle remain substantially the same as those before the pre-treatment was taken.

(2) Frosting: The glass bottle that has been removed out of the pre-treatment solution and still carries some pre-treatment solution attached to the bottle surface is immersed into a frosting solution to have the surface of the glass bottle corroded. The composition of the frosting solution includes nitric acid (HNO₃) 15-40%, ammonium hydrofluoride (NH₄HF₂) 30-60%, hydrofluoric acid (HF) 0-10%, water (H₂O) 0-45%, and hydrochloric acid (HCl) 0-1%. The immersion time in the frosting solution is approximately 1-5 minutes.

(3) Rinsing: The glass bottle removed from the frosting solution shows a white layer of reaction product that is produced by the reaction between the bottle and the frosting solution and the rising step is to flush away the layer of product.

(4) Drying: High temperature air streams are applied or natural drying is adopted to remove water from the surface of the glass bottle.

The surface of the glass bottle so treated is smooth and glossy and shows a scale like pattern. Each scale of the scale like pattern looks almost the same as the conventional frosted glass, yet the adjacent ones of the scales are of different angles, whereby the scales glitter with reflection of light. Further, due to the addition of nitric acid that was not used in the known pre-treatment solution, the scales of the scale-like pattern have substantially the same size, helping enhancing the brightness thereof. Further, since the surface of the glass bottle is smooth and glossy and shows a scale like pattern, the tactility matches the frosted glass that is formed through the known frosting technique. Further, the scale like pattern of the frosted surface that is formed according to the present invention is clear and distinct so that surface contamination of the glass, such as hand mark staining, does not look so obvious. Further, the frosted surface formed according to the present invention allows for direct performance of gold foil stamping thereon and due to the subtle difference of angles of the scales of the scale like pattern formed on the surface, which is the substrate on which the foil stamping is carried out, the foil stamped surface shows glossiness.

The reason that the frosting process of glass that induces corrosion of the glass surface forms a scale like pattern is conjectured as follows. The frosting solution contains nitric acid (HNO₃) and ammonium hydrofluoride (NH₄HF₂), which react with each other and produce hydrofluoric acid (HF) and ammonium nitrate (NH₄NO₃). Hydrofluoric acid corrodes and cuts the glass surface and the reaction between the hydrofluoric acid and the glass produces a large amount of reaction product (which is mainly silicon fluorides) around the glass surface. The reaction product comprises white dissoluble fluorides, which are in the form of thin films attached to the glass surface. Ammonium nitrate helps suppressing the spreading of the reaction product of hydrofluoric acid and the glass in the frosting solution. (In the conventional glass frosting techniques, the products of the reaction between the frosting solution and the glass does not form a thin film as that formed according to the present invention and thus, the products spread out in the solution.) After the reaction products are formed on the glass surface, through pores formed in the film, hydrofluoric acid takes reaction with the glass surface. Thus, as conventionally applied, in the time period when the glass is immersed in the frosting solution, the whole glass surface is subjected, under the same condition, to corrosion to different results. For the present invention, corrosion is carried out at the same condition and consequently, carrying out reaction at different reaction conditions leads to different scale like patterns. Further, the time period for immersion in the frosting solution is of importance. For an immersion time less than 1 minute, the glass surface looks the same as that before immersion and no change occurs. This is because of the film of reaction product formed on the glass surface, which slows down the performance of corrosion. For an immersion time exceeding 5 minutes, the glass surface becomes excessively roughened, losing glossiness. For a time period for immersion in the frosting solution between 1-5 minutes, the longer the time when the immersion is made, the more clear and more distinct the scale like pattern looks. Further, through water rinsing to remove the reaction product, the glass surface may show the scale like pattern that is hard to image in the conventional frosting techniques.

In the above described frosting process according to the present invention, if hydrofluoric acid is omitted from the frosting solution, the glass surface also forms the scale like pattern, but using a frosting solution that contains hydrofluoric acid makes the scale like pattern significantly distinct on the glass surface. Yet, it is noted that for a percentage of hydrofluoric acid mixed in the frosting solution exceeding 10%, the scale like pattern is only locally formed and areas outside the scale like pattern remain the same as those were before the reaction. If the percentage of ammonium hydrofluoride contained in the frosting solution is less than 30%, then the scale like pattern is only locally formed and areas outside the scale like pattern remain the same as those were before the reaction; and for a percentage exceeding 60%, the scale like pattern is also formed in a localized fashion and areas outside the scale like pattern forms the conventional frosted texture that is the same as that made with the known techniques. Further, for a percentage of the nitric acid contained in the frosting solution less than 15% or greater than 40%, the scale like pattern is only locally formed and areas outside the scale like pattern remain the same as those were before the reaction. If the frosting solution contains an excessive amount of water, then the scales of the scale like pattern trend to grow larger. One of the functions of hydrochloric acid contained in the frosting solution is that hydrochloric acid may destroy the attached film of white product of fluorides. Thus, the percentage of hydrochloric acid added in the frosting solution is of reversed proportion to the speed of hydrofluoric acid corroding the glass surface and may help changing the size of the scale like pattern so generated.

To provide a clear comparison between the present invention and a conventional frosting technique, a table of comparison is given as follows.

| | the present invention | | conventional technique | |
|---|---|---|---|---|
| pre-treatment solution | H₂O | 60-80% | H₂O | 75-90% |
| | HF | 10-20% | HF | 10-25% |
| | HNO₃ | 10-20% | | |
| pre-treatment time | 5 seconds | | 5 seconds | |
| frosting solution | HNO₃ | 15-40% | NH₄HF₂ | 40-50% |
| | NH₄HF₂ | 30-60% | HF | 25-10% |
| | HF | 0-10% | H₂O | 15-30% |
| | H₂O | 0-45% | | |
| | HCl | 0-1% | | |

| | | |
|---|---|---|
| time for immersion in | 1-5 minutes | 10-20 seconds |
| frosting solution | | |
| result | scale like pattern on | frosted texture on bottle |
| | bottle surface | surface |

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for surface frosting of glass product, comprising the following steps:
(a) pre-treating a glass product by immersing the glass product in a pre-treatment solution for 3-10 seconds to remove grease/oil and/or contamination from a surface of the glass product;
(b) immersing the pre-treated glass product in a frosting solution for 1-5 minutes; and
(c) rinsing the glass product with water and then drying to form a final product having the surface frosted.

2. The method for surface frosting of glass product according to claim 1, wherein the pre-treatment solution has a composition including water (H₂O) 60-80 wt %, hydrofluoric acid (HF) 10-20 wt %, and nitric acid (HNO₃) 10-20 wt %.

3. The method for surface frosting of glass product according to claim 1, wherein the frosting solution has a composition including nitric acid (HNO₃) 15-40 wt %, ammonium hydrofluoride (NH₄HF₂) 30-60 wt %, hydrofluoric acid (HF) 0-10 wt %, water (H₂O) 0-45 wt %, and hydrochloric acid (HCl) 0-1 wt %.

4. A glass product made with the method according to claim 1, which has a surface that provides smooth tactility and shows an outer visual appearance of a scale like pattern.
